(19) United States
(12) Patent Application Publication
(10) Pub. No.: US 2017/0033370 A1
(43) Pub. Date: Feb. 2, 2017

(54) MOISTURE-RESISTIVE GRAPHENE MEMBRANE CATHODE FOR LITHIUM-AIR BATTERY IN AMBIENT CONDITIONS

(71) Applicant: The Regents of the University of California, Oakland, CA (US)

(72) Inventors: Xiangfeng Duan, Los Angeles, CA (US); Xing Zhong, Los Angeles, CA (US); Yuxi Xu, Los Angeles, CA (US)

(21) Appl. No.: 15/301,696

(22) PCT Filed: Apr. 3, 2015
(86) PCT No.: PCT/US2015/024288

§ 371 Date: Oct. 3, 2016

Related U.S. Application Data
(60) Provisional application No. 61/975,546, filed on Apr. 4, 2014.

(51) Int. Cl. H01M 4/96; H01M 4/88; H01M 4/38; H01M 4/86; H01M 12/06; H01M 12/08

(52) U.S. Cl. CPC H01M 4/96; H01M 12/06; H01M 12/08; H01M 4/382; H01M 4/8605; H01M 4/8882; H01M 4/8878

(57) ABSTRACT

A metal-air battery includes: (1) a metal anode; (2) a cathode including a graphene membrane; and (3) an electrolyte disposed between the metal anode and the cathode, where the graphene membrane includes graphene in an amount of at least 80% by weight of the graphene membrane.

### CROSS REFERENCE TO RELATED APPLICATION

This application claims the benefit of U.S. Provisional Application Ser. No. 61/975,546, filed on Apr. 4, 2014, the content of which is incorporated herein by reference in its entirety.

### TECHNICAL FIELD

This disclosure generally relates to battery electrodes and, more particularly, to battery electrodes based on graphene.

### BACKGROUND

The aprotic electrolyte lithium (Li)-air battery, as one of the most prominent high energy density systems, has garnered intensive attention because of its alluring potential that could far exceed the energy density of Li-ion batteries over several magnitudes. The central question at present is how to achieve a comprehensive battery system that can present stable cycling performance in ambient conditions without sacrificing energy density. To this regard, several factors have been considered such as the stability of an electrolyte, a cathode, and an oxygen reaction catalyst. For example, efforts have been made on electrolyte screening, one of the major hurdlers in the stability and cycle life of a Li-air battery. Investigations have been made on various aprotic systems; however, their suitability as electrolytes in a Li-air battery remains in question due to possible instability in the presence of reactive oxygen species. Moreover, these efforts have not been demonstrated in ambient conditions. A Li-air battery directly operating in ambient conditions can behave very differently than in a pure oxygen environment. On the one hand, in a discharging process, a low oxygen concentration in air would constrain O₂ accessibility to a cathode, thus specifying a high surface area of the cathode would be desirable to sustain an oxygen reduction reaction. While in a charging process, a slow gas diffusion and a localized high oxygen concentration at a cathode surface would also specify the desirability of a cathode with enough active sites. On the other hand, the water vapor in the ambient air can sabotage an inner cathode system by readily reacting with a discharge product Li₂O₂ and corroding a Li anode. Oxygen selective membranes, such as fluorinated hydrocarbons, polyethers, and polysiloxanes-based membranes, have been proposed to be applied at a cathode. However, the relatively low oxygen permeability, poor chemical stability, and high resistivity of these oxygen selective membranes would further complicate the system. A cathode composed of single-walled nanotubes (SWNTs) and an ionic liquid embedded in a gel also has been proposed. Although a relatively high cathode capacity is achieved when normalized by the SWNTs, the cathode capacity would be greatly lowered if inactive components, such as the ionic liquid and gel, are further considered. Also, a high charge over-potential (over 5 V) and complexity of this system would further complicate its practical application.

It is against this background that a need arose to develop the embodiments of a moisture-resistive graphene membrane cathode described in this disclosure.

### SUMMARY

In some embodiments, a metal-air battery includes: (1) a metal anode; (2) a cathode including a graphene membrane; and (3) an electrolyte disposed between the metal anode and the cathode, where the graphene membrane includes graphene in an amount of at least 80% by weight of the graphene membrane.

In additional embodiments, a metal-air battery includes: (1) a metal anode; (2) a cathode including a graphene membrane and a catalyst incorporated in the graphene membrane, where the catalyst is configured to catalyze at least one of oxygen reduction and oxygen evolution; and (3) an electrolyte disposed between the metal anode and the cathode.

In further embodiments, a method of forming a cathode for a metal-air battery includes: (1) dispersing graphene oxide in a solvent to form a graphene oxide solution; (2) coating the graphene oxide solution on a current collector to form a coated current collector; (3) subjecting the coated current collector to cooling and dehydration to form a graphene oxide membrane on the current collector; and (4) annealing the graphene oxide membrane to form a graphene membrane on the current collector.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: A schematic of a metal-air battery.

FIG. 2: A schematic of a moisture-resistive graphene membrane cathode.

FIG. 3: A schematic of a scalable preparation of a graphene membrane cathode. Scale bars are 1 cm in a), b), and c), and 0.5 cm in d).

FIG. 4: a), b) Cross-sectional scanning electron microscope (SEM) image of an about 20 μm graphene membrane cathode. Scale bars are 20 μm and 10 μm. c) Galvanostatic discharge/charge curve for graphene membrane cathode in oxygen.

FIG. 5: a) Galvanostatic discharge/charge curve for a graphene cathode in ambient conditions. b) X-ray diffraction (XRD) analysis of a pristine graphene electrode, a discharged electrode, and a recharged electrode. c) Galvanostatic cycling of a three-dimensional (3D) graphene cathode in pure oxygen and ambient air. SEM image of d) pristine, e) discharged, and f) recharged graphene cathode.

FIG. 6: a) Galvanostatic cycling of a Li-air cell with about 20 μm graphene membrane cathode under a capacity of a) about 1,440 mAh/g, c) about 2,870 mAh/g, and e) about 5,750 mAh/g. Cycling profiles under a capacity of b) about 1,440 mAh/g, d) about 2,870 mAh/g, and f) about 5,750 mAh/g in ambient air.

FIG. 7: Galvanostatic cycling of carbon paper electrode in ambient air.

FIG. 8: SEM image of a 3D graphene cathode after several cycles. Scale bars for SEM are 10 μm and 2 μm (insert).

FIG. 9: Galvanostatic discharge curve of a graphene membrane cathode-based Li-air battery for 90 hr.

### DETAILED DESCRIPTION

Stable, high energy density Li-air battery, with cycle life comparable or superior to its predecessor Li-ion battery, is projected to be an alternative for future electrical power sources. However, challenges have been revealed in almost every aspect of the Li-air system, particularly when operating in ambient conditions. A catalytic, high surface area and interconnected conductive cathode that allows deposition of large quantities of an insulating discharge product, facile charge transport, and fast oxygen diffusion and reaction is desired. Furthermore, water moisture has a tendency to react with the main discharge product Li₂O₂, and corrode a Li metal negative electrode as well. These factors are constraints for a Li-air battery to operate in ambient conditions. Here, embodiments of this disclosure are directed to a moisture-resistive graphene membrane cathode that can function as a water-resistive, catalytically efficacious cathode in a Li-air system under ambient air conditions. In some embodiments, a Li-air battery based on the moisture-resistive graphene membrane cathode shows robust performance in ambient conditions with a high coulombic efficiency, a low charging over-potential, and a sustained cycling ability. Embodiments of this disclosure allow the development of an industrially-scalable approach for super-high energy density primary and secondary Li-air battery applications. Although some embodiments are described in the context of Li-air batteries, embodiments of a moisture-resistive graphene membrane electrode can be implemented in the context of other energy storage systems, such as other types of metal-air batteries.

Embodiments of a moisture-resistive graphene membrane cathode can be implemented to improve battery performance in both primary (e.g., discharge only) and secondary (rechargeable) applications. In some embodiments, a system as a primary battery is demonstrated with over about 20 times higher energy density than a commercial battery.

Graphene is an allotrope of carbon, and its structure is typically one-atom-thick sheets of sp²-bonded carbon atoms that are packed in a honeycomb crystal lattice. In some embodiments, graphene is provided in the form of thin sheets of substantially a monolayer of carbon atoms that can be envisioned as unrolled carbon nanotubes, although a bilayer or other multilayer of graphene is also encompassed by this disclosure.

Graphene, as a single atomic layer, two-dimensional (2D) structure, is desirable in a Li-air battery as an electrode, in view of its high electrical conductivity and high surface area. In addition, defects and functional groups on reduced graphene oxide can serve as catalytic active sites for oxygen reduction/evolution reactions. The presence of sp³ bonding associated with edge and defects sites in graphene can function as metal-free or substantially metal-free catalytic sites in a Li-air battery. Also, defects and functional groups on graphene can favor the formation of isolated Li₂O₂ particles that is energetically favorable.

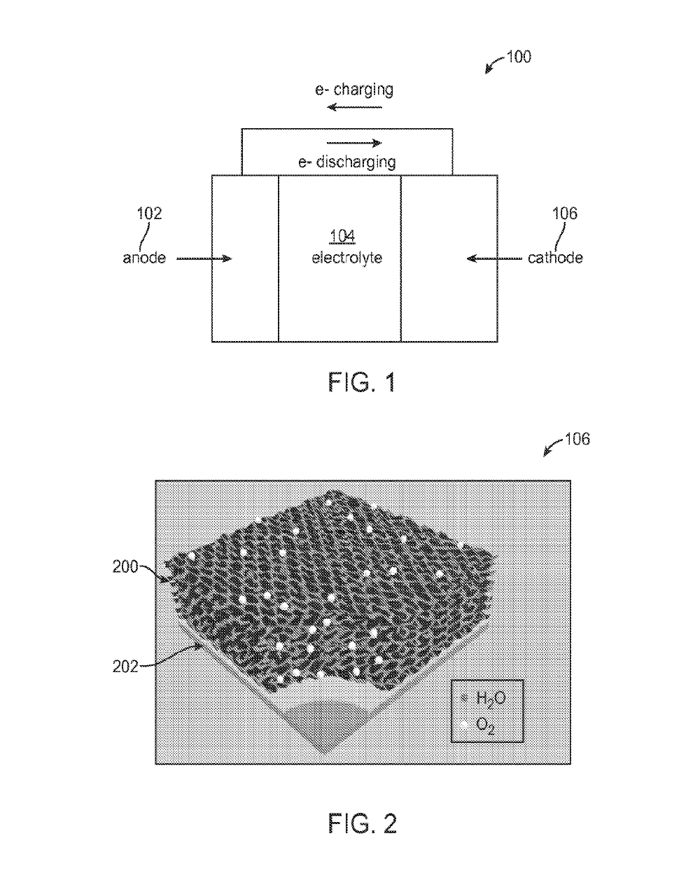

FIG. 1 is a schematic of a metal-air battery 100 according to an embodiment of this disclosure. The battery 100 includes an anode 102, a cathode 106, and an electrolyte 104 that is disposed between the anode 102 and the cathode 106. In the case of a Li-air battery, the anode 102 includes lithium metal, although other metals (e.g., zinc or aluminum) or metal alloys can be included in place of, or in combination with, lithium metal. During discharging, the battery 100 can operate based on oxidation of lithium at the anode 102, forming lithium ions and electrons, and reduction of oxygen (O₂) at the cathode 106, based on reaction of oxygen with lithium ions to form a discharge product, thereby inducing a current flow. In the case of charging for a secondary (rechargeable) application, lithium metal is plated at the anode 102, and oxygen is formed at the cathode 106. The electrolyte 104 is a polar, aprotic electrolyte, although other types of electrolytes are contemplated, such as aqueous, solid state, and mixed aqueous/aprotic electrolytes. Examples of suitable aprotic electrolytes include organic amides, such as N,N-dimethylacetamide and dimethyformamide. Other examples of suitable aprotic electrolytes include organic carbonates, esters, and ethers.

The battery 100 can be implemented to operate in ambient conditions. Ambient conditions (or near ambient or other conditions different from pure oxygen) can be characterized by a partial pressure of oxygen of up to about 0.5 atm, up to about 0.45 atm, up to about 0.4 atm, up to about 0.35 atm, up to about 0.3 atm, up to about 0.25 atm, or up to about 0.21 atm, and down to about 0.2 atm, down to about 0.15 atm, or less. Relative humidity under ambient conditions (or near ambient or other conditions different from pure oxygen) can be represented as a percentage between 0% and 100%, such as at least about 5%, at least about 10%, at least about 20%, at least about 30%, or at least about 40%, and up to about 60%, up to about 80%, up to about 90%, or more. Other implementations of the battery 100 are contemplated for operation under other environments, such as a pure or substantially pure oxygen environment.

The cathode 106 is a moisture-resistive graphene membrane cathode that allows the battery 100 to operate well in ambient conditions. A large surface area and a porous structure of the graphene membrane cathode 106 provide a large number of defect sites and functional groups for oxygen reduction and evolution reactions to occur at a low over-potential, and the porous structure also allows the battery 100 to overcome a low oxygen concentration and a slow oxygen diffusion in ambient air conditions. Moreover, a three-dimensional (3D) interconnected conductive graphene membrane ensures good and stable electron transport during oxygen reduction and evolution reactions. And, a cave-like architecture with inner passages or tunnels and a hydrophobic nature of reduced graphene oxide allow the graphene membrane to resist moisture in ambient air from penetrating into an interior of the graphene membrane. As a result, the battery 100 incorporating the graphene membrane cathode 106 can achieve high capacity and long cycle life in both oxygen and ambient air conditions.

FIG. 2 is a schematic of the cathode 106 according to an embodiment of this disclosure. As shown in FIG. 2, the cathode 106 includes a graphene membrane or layer 200 and a current collector 202, and the graphene membrane 200 is coated or otherwise disposed on the current collector 202. The current collector 202 can include a carbon-based or other fibrous material, such as carbon cloth or paper.

The structure of the graphene membrane 200 satisfies several desirable criteria. For example, the graphene membrane 200 can include graphene sheets that are conjugated into a 3D framework. The graphene sheets in the 3D framework can be highly interconnected and interlocked together to mitigate against their restacking and to maintain a porous monolithic structure with a large specific surface area, such as at least about 200 m² g⁻¹, at least about 300 m² g⁻¹, at least about 400 m² g⁻¹, at least about 500 m² g⁻¹, at least about 600 m² g⁻¹, at least about 700 m² g⁻¹, at least about 800 m² g⁻¹, at least about 900 m² g⁻¹, or at least about 1,000 m² g⁻¹, and up to about 1,300 m² g⁻¹, up to about 1,500 m² g⁻¹, up to about 1,700 m² g⁻¹, or up to about 2,000 m² g⁻¹, or more, based on methylene blue adsorption. The structure of the graphene membrane 200 can be in the form of a gel, and the gel can be solvated with an electrolyte or other liquid medium.

As another example, pores in the graphene membrane 200 can be sufficiently large and integrated into a porous structure to form a network of inner passages or tunnels for efficient oxygen diffusion throughout the network. A pore size of the graphene membrane 200 can be in a range of at least about 5 nm, at least about 10 nm, at least about 100 nm, at least about 200 nm, at least about 300 nm, at least about 400 nm, at least about 500 nm, at least about 600 nm, at least about 700 nm, at least about 800 nm, at least about 900 nm, or at least about 1 μm, and up to about 2 μm, up to about 5 μm, up to about 10 μm, or more. As can be appreciated, pores of the graphene membrane 200 can have a distribution of sizes, and a pore size can refer to an effective size across the distribution of sizes or an average or median of the distribution of sizes. An example of a method for determining a pore size is the so-called “challenge test,” in which spheroidal particles of known size distributions are presented to a porous structure and changes downstream are measured by a particle size analyzer. Using the challenge test, a pore size can be determined from a calibration graph, with the pore size corresponding to an effective cut-off point of the porous structure. In some implementations, this cut-off point can correspond to a maximum size of a spheroidal particle that can pass through substantially unblocked by the porous structure. Other methods for determining pore sizes include, for example, optical or scanning methods.

Another characterization of the graphene membrane 200 is its porosity, which is a measure of the extent of voids resulting from the presence of pores or any other open spaces. A porosity can be represented as a ratio of a volume of voids relative to a total volume, namely between 0 and 1, or as a percentage between 0% and 100%. In some implementations, a porosity can be at least about 0.01, at least about 0.05, or at least about 0.1 and up to about 0.95, and, more particularly, a porosity can be in the range of about 0.1 to about 0.9, about 0.2 to about 0.9, about 0.3 to about 0.9, about 0.4 to about 0.9, about 0.5 to about 0.9, about 0.5 to about 0.8, or about 0.6 to about 0.8. Methods for determining porosity include, for example, porosimetry and optical or scanning methods.

As another example, a moisture-resistive nature of the graphene membrane 200 can mitigate against penetration of moisture in ambient air into an interior of the graphene membrane 200. The moisture-resistive nature of the graphene membrane 200 can be characterized in terms of its wettability, which can be specified based on a contact angle between a surface of the graphene membrane 200 and a drop of liquid water disposed on the surface. The contact angle can be the angle at which the liquid-vapor interface intersects the solid-liquid interface. The moisture-resistive nature of the graphene membrane 200 can yield contact angles greater than or equal to about 90°, such as greater than or equal to about 95°, greater than or equal to about 100°, greater than or equal to about 105°, greater than or equal to about 110°, greater than or equal to about 115°, or greater than or equal to about 120°, and up to about 140°, up to about 150°, or more.

As another example, the graphene membrane 200 can have high electrical conductivity, such as at least about 500 S m⁻¹, at least about 600 S m⁻¹, at least about 700 S m⁻¹, at least about 800 S m⁻¹, at least about 900 S m⁻¹, or at least about 1,000 S m⁻¹, and up to about 1,300 S m⁻¹, up to about 1,500 S m⁻¹, or up to about 2,000 S m⁻¹, or more. The high electrical conductivity allows the graphene membrane 200 to be used directly in the cathode 106, with the omission of a polymer binder and conductive additives (or their inclusion at reduced levels). The inclusion of a polymer binder and conductive additives can increase the complexity of electrode preparation, and also can impose an adverse impact on capacity and energy density performance. In some implementations, graphene is included in the graphene membrane 200 in an amount of at least about 60% by weight of the graphene membrane 200, such as at least about 65% by weight, at least about 70% by weight, at least about 75% by weight, at least about 80% by weight, at least about 85% by weight, at least about 90% by weight, or at least about 95% by weight, and up to about 98% by weight, up to about 99% by weight, or more. In some implementations, the graphene membrane 200 can consist of, or can consist essentially of, graphene.

As a further example, the graphene membrane 200 can be tuned with different thicknesses for various energy and power specifications, such as in a range of at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 5 μm, at least about 10 μm, at least about 15 μm, or at least about 20 μm, and up to about 30 μm, up to about 50 μm, up to about 100 μm, or more.

In some embodiments, a graphene membrane, such as the graphene membrane 200, can be formed through self-assembly of graphene oxide sheets into a graphene oxide membrane, followed by reducing the graphene oxide membrane to form the graphene membrane. Specifically, graphene oxide, such as in the form of graphene oxide sheets, can be dispersed in a solvent or other liquid to form a graphene oxide solution, such as at a concentration in a range of about 0.5 mg/ml to about 20 mg/ml, about 1 mg/ml to about 10 mg/ml, or about 4 mg/ml. Next, the graphene oxide solution can be coated or otherwise disposed on a current collector to form a coated current collector. Next, the coated current collector can be subjected to cooling and dehydration, such as by freeze-drying at a temperature in a range of about −150° C. to about −10° C. or about −100° C. to about −50° C., to form a graphene oxide membrane on the current collector. Next, the graphene oxide membrane can be annealed to form a graphene membrane on the current collector, such as by annealing under an argon atmosphere, or another inert atmosphere, at a temperature in a range of about 200° C. to about 600° C., about 300° C. to about 500° C., or about 400° C. It is also contemplated that self-assembly and reduction of graphene oxide can be combined in one operation, instead of being performed sequentially.

Additional embodiments of a graphene membrane cathode are encompassed by this disclosure. For example, a graphene membrane of some embodiments can incorporate one or more catalysts, such as including or formed of a metal (e.g., a transition metal, a post-transition metal, or a metalloid), a metal oxide, or a binary, ternary, quaternary, or high order metal alloy, for catalyzing either, or both, oxygen reduction and evolution reactions to improve a discharging/charging rate and to attain even higher power densities. For example, a ternary metal alloy catalyst, such as platinum cobalt molybdenum (PtₓCo_{y}Mo_{z}) alloy particles, can yield improved oxygen reduction and evolution activities in an aprotic electrolyte Li-air battery. An amount of a catalyst (or a combined amount of all catalysts) in a graphene membrane can be at least about 1% by weight of the graphene membrane, such as at least about 2% by weight, at least about 5% by weight, at least about 10% by weight, at least about 15% by weight, or at least about 20% by weight, and up to about 30% by weight, up to about 35% by weight, up to about 40% by weight, or more. The incorporation of a catalyst in a graphene membrane can occur via growth of the catalyst on graphene oxide or graphene sheets, or mixing or dispersion of the catalyst with, or among, graphene oxide or graphene sheets. It is also contemplated that the incorporation of a catalyst can be carried out in combination, or sequentially, with respect to self-assembly and reduction of graphene oxide to form a graphene membrane.

In some embodiments, a battery incorporating a graphene membrane cathode, such as the battery 100, can attain a number of performance benefits in both oxygen and ambient air conditions. For example, a low over-potential for charging can be attained, such as up to about 1.1 V, up to about 1 V, up to about 0.9 V, or up to about 0.8 V, and down to about 0.6 V, down to about 0.5 V, down to about 0.4 V, or less. As another example, a high coulombic efficiency can be attained, such as at least about 80%, at least about 85%, at least about 90%, at least about 95%, or at least about 98%, and up to about 99%, up to about 99.5%, or more. As a further example, a high discharge capacity can be attained, such as at least about 1,000 mAh/g, at least about 1,400 mAh/g, at least about 2,000 mAh/g, at least about 2,400 mAh/g, at least about 2,800 mAh/g, at least about 3,000 mAh/g, at least about 3,400 mAh/g, at least about 3,800 mAh/g, at least about 4,000 mAh/g, at least about 4,400 mAh/g, at least about 4,800 mAh/g, at least about 5,000 mAh/g, at least about 5,400 mAh/g, at least about 5,800 mAh/g, at least about 10,000 mAh/g, or at least about 15,000 mAh/g, and up to about 18,000 mAh/g or more, and at least about 70% of an initial discharge capacity can be retained after 50 cycles, such as at least about 75%, at least about 80%, at least about 85%, at least about 90%, or at least about 95%, and up to about 98%, up to about 99%, or more.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Example 1

### Results and Discussion

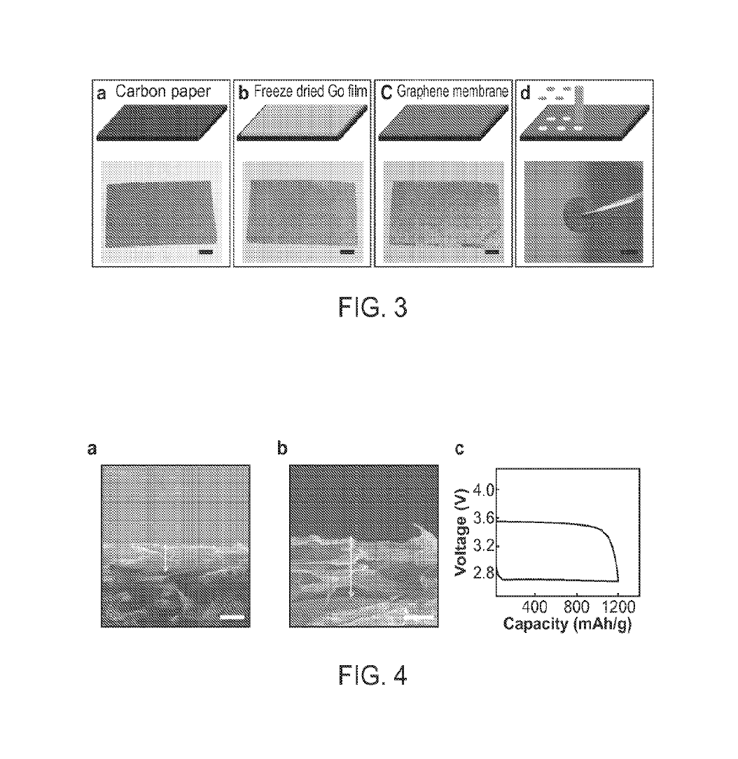

FIG. 3 shows a schematic of a scalable preparation of a graphene membrane cathode on carbon paper. Graphene oxide (GO) was prepared by the Hummer's method, such as reported in Hummers W. S., Offeman R. E., J. Am. Chem. Soc., 1958, 80(6):1339, the disclosure of which is incorporated herein by reference in its entirety. The as-prepared GO was dispersed to form an about 4 mg/ml solution and was uniformly coated on the pre-treated carbon paper. Then the sample was quickly or almost immediately put into a freezer at about −75° C. for about 30 min and then freeze-dried for at least about 10 hr. A 3D porous GO membrane was formed on the carbon paper as is shown in FIG. 3b. The GO was further reduced to graphene by annealing in an argon (Ar) atmosphere at about 400° C. as the color changes from deep yellow into dark grey as shown in FIG. 3c. Finally, electrodes were obtained by cutting into substantially round shapes for coin cell battery assembly as shown in FIG. 3d. The graphene membrane or film can be tuned with different thicknesses for various energy and power specifications.

FIGS. 4a and b shows an as-prepared graphene thin film with about 20 μm in thickness on carbon paper. Galvanostatic discharge/charge is performed in pure oxygen first as shown in FIG. 4c. A typical discharge voltage for the graphene membrane cathode is about 2.7 V while the charging shows a long platform at about 3.6 V. For non-aqueous aprotic Li-air batteries, the thermodynamic potential is about 2.96 V (vs. Li) based on the proposed net electrochemical reaction: Li⁺+e⁻+1/2O₂→1/2Li₂O₂. The low over-potential for charging (about 0.6-0.8 V) is consistent with results of using LiNO₃/N,N-dimethylacetamide (DMA) as an electrolyte. In other non-aqueous aprotic electrolytes (e.g., organic carbonate, ether, and so forth), the over-potential for charging is normally about 1.2 to about 1.5 V, and this can result in a large inefficient energy storage usage.

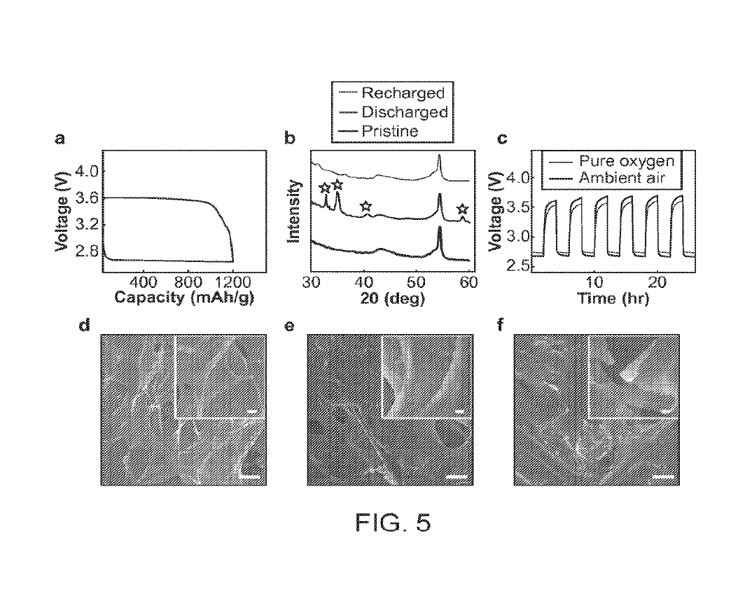

While operating under ambient conditions (FIG. 5a), the discharge/charge behavior is similar as that in oxygen. About 100% coulombic efficiency is achieved in ambient air. The slight shift in discharge/charge voltage is mostly attributed to an oxygen concentration difference. An X-ray diffraction (XRD) analysis (FIG. 5b) is also performed to characterize the discharge product. The discharged cathode in the ambient conditions shows reflections at about 33°, about 35°, about 41°, and about 58°, which disappear on both pristine and recharged graphene electrodes. No other noticeable peaks are observed. An electrolyte with high dielectric constant can be effective in electrochemically activating CO₂, giving a Li₂CO₃-involved discharge/charge process. DMA, with a moderate dielectric constant, might undergo such a reaction pathway, competing with the typical reaction mechanism with Li₂O₂ as the discharge product. However, due to the low concentration of CO₂ in air, this CO₂-involved discharge/charge pathway might be involved in a small portion of the whole reaction. It is also evident by the low charging potential as the charging platform is typically higher than about 4.2 V for CO₂-involved discharge/charge pathway (FIG. 5c). FIG. 5d, e, and f shows scanning electron microscope (SEM) images of the graphene cathode at pristine, discharged, and charged state, respectively. As indicated in FIG. 5e, there are large amounts of Li₂O₂ particles anchoring on the graphene sheet surface at the discharged state, consistent with the XRD data. It also shows that, after discharge, the graphene cathode is able to retain its 3D interconnected porous network and therefore ensures enough room for oxygen to diffuse inward. Almost all the Li₂O₂ particles disappear at the charged state as indicated in FIG. 5f.

Galvanostatic Cycling Behavior

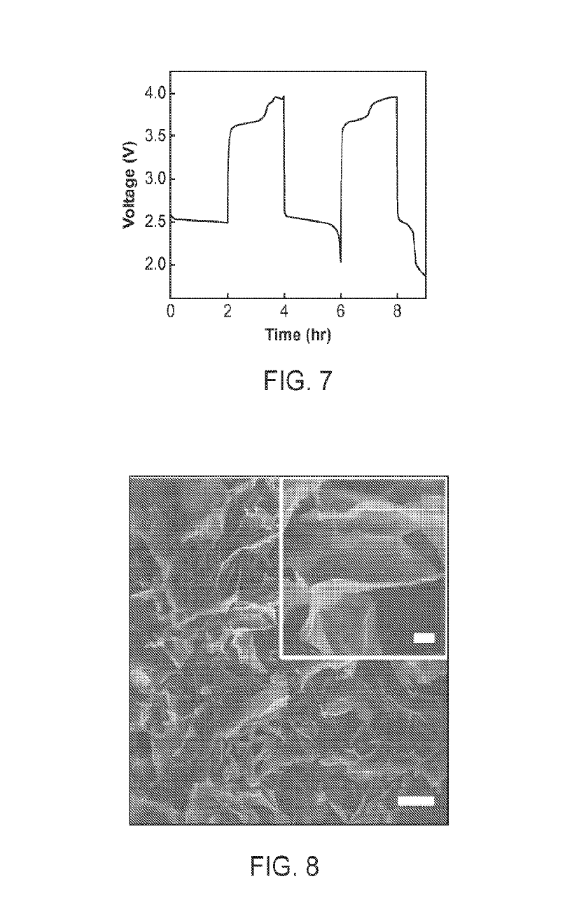

To further demonstrate the advantages of the proposed moisture-resistive graphene membrane cathode, cycling test is performed on the graphene membrane cathode in both oxygen and ambient conditions. Firstly, the test is performed on the bare carbon paper to exclude the contribution from the carbon paper. The carbon paper shows negligible capacity and starts to fail from the second cycle (FIG. 7). For the graphene cathode (FIG. 5c) operating in the ambient conditions, it shows sustainable cycling performance, almost the same behavior as that in the pure oxygen, with an end voltage of about 3.7 V and negligible voltage polarization with further cycling. It is believed that the charging polarization is correlated to the inefficiency of Li₂O₂ decomposition reaction. For the graphene membrane cathode, upon charging, the low over-potential and little polarization indicate that most of the Li₂O₂ are decomposed even in the ambient conditions.

There are several reasons for the sustained cycling for graphene membrane cathode-based battery in both oxygen and ambient conditions of this example. First, micron-sized pores ensure O₂ diffusion while a large surface area ensures the large accessibility of the gas, thus providing a high density of reactive sites for Li₂O₂ reactions, in particular operating in air with a low oxygen partial pressure. Secondly, the 3D interconnected conducting graphene framework ensures that the insulating discharge products would not isolate the electrode and block the electron transfer, particularly in a charging process. Moreover, the hydrophobic 3D graphene acts as a moisture barrier to resist high moisture concentration inside the cathode.

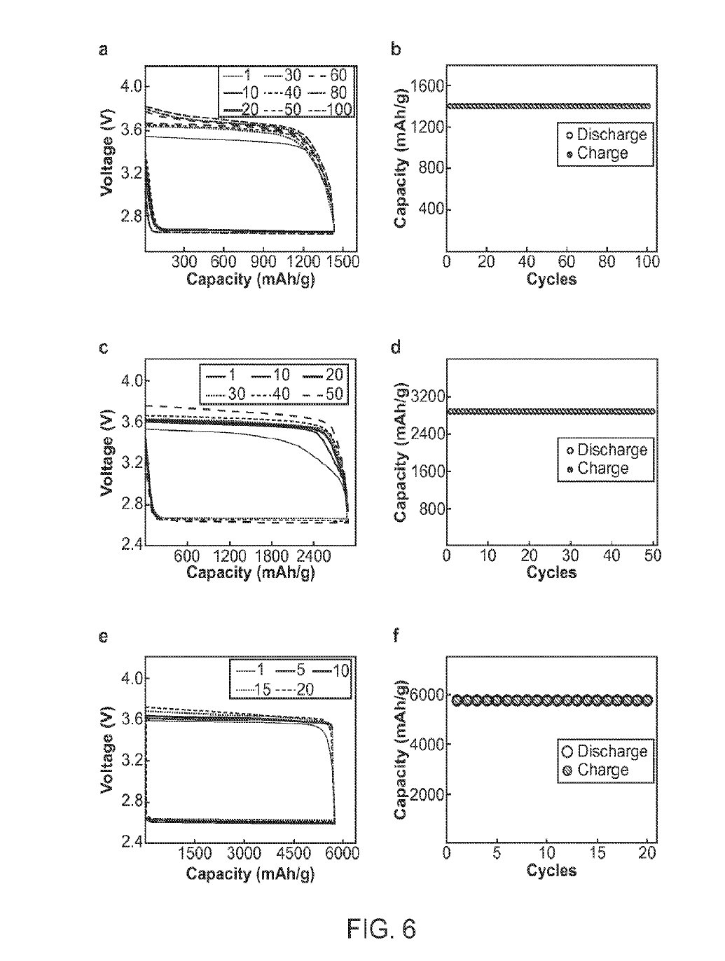

The cycling performance is further probed by the capacity-limited test, which is a generally accepted method for Li-air batteries, given its distinct reaction mechanism compared to a Li-ion battery. The Li-air battery is firstly cycled with a fixed capacity at about 1,440 mAh/g per cycle. The battery cycles with almost the same charge/discharge behavior with little polarization on charging. It is also noticeable that the over-potential increases readily with continuous cycling after 50 cycles and reaches about 3.8 V when approaching 100 cycles (FIG. 6a). It is believed that, with cycles deepening, parts of the Li₂O₂ will be accumulated on the graphene surface. The slow increase in the over-potential during charging on deep cycling might be attributed to the electron transport constraints through these accumulated Li₂O₂ on graphene sheet. FIG. 8 shows a SEM image of a graphene cathode after several cycles. As expected, the graphene is thickened in morphology compared to a pristine one. With deeper discharging, higher capacity can be achieved. For example, FIGS. 6c and d shows that over about 2,800 mAh/g discharge capacity is readily achieved with little charge polarization for 50 cycles. It is also evident (FIGS. 6e and f) that the graphene membrane shows extremely stable cycling profile in 20 cycles, achieving a capacity over about 5,700 mAh/g.

Capacity Consideration

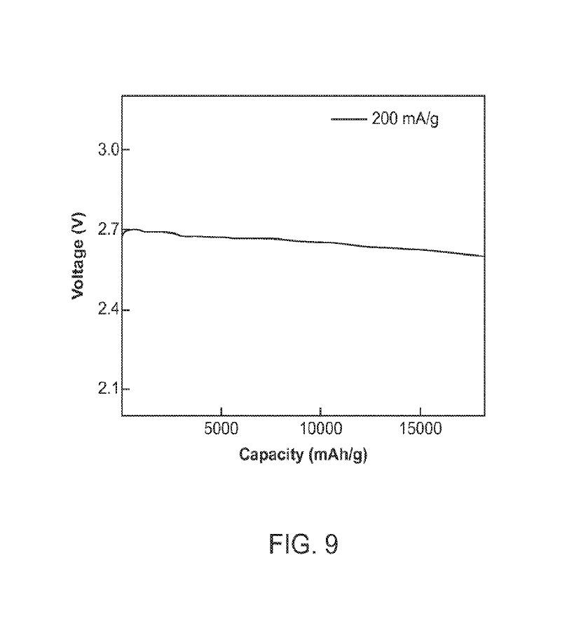

The capacity of a Li-air battery is affected by an electrode porosity to provide Li₂O₂ storage and by oxygen diffusion through electrolyte flooded pores. The question is what would be an upper or theoretical value of the capacity based on the proposed porous graphene membrane cathode. If assuming an average thickness of Li₂O₂ coating on graphene is about 100 nm, the calculated capacity can already reach over about 170,000 mAh/g. However this theoretical capacity value would be constrained by gas diffusion and the decreased operating voltage with accumulated insulating discharge product (U₂O₂). A single discharge is performed at about 200 mA/g on the porous graphene membrane cathode in ambient conditions, and the discharge is cut-off at about 2.6 V. The battery discharge over 90 hr can deliver a capacity of more than about 18,000 mAh/g (FIG. 9).

Other reports normalize the capacity by an active component in a cathode. However the inactive parts (e.g., binder) can substantially decrease the effective cathode capacity in practice, as is the case in a commercial Li-ion or primary Li—MnO₂ battery. In the primary Li—MnO₂ battery, the active component in the cathode is MnO₂ that takes up to about 50% of a total weight of the cathode. Inactive components would further lower the actual cathode capacity or energy density in the final battery configuration. In the configuration of the graphene membrane cathode of this example, graphene is highly conductive and interconnected by itself; thus, little or no binder or other inactive materials (such as carbon black) are needed, and thus the capacity is substantially the actual capacity for the whole cathode material.

### CONCLUSION

In conclusion, a high energy density rechargeable Li-air battery based on a moisture-resistive graphene membrane cathode is demonstrated in ambient conditions. The unusual 3D porous architecture of the rationally-designed graphene cathode serves several purposes. First, it serves as a high surface area cathode, which ensures a high capacity of the battery. Second, the interconnected 3D conducting graphene framework ensures the electron transfer with accumulated insulating Li₂O₂ on both charging and discharging. Third, a cave-like membrane structure with a certain thickness and hydrophobic nature serves as a moisture barrier while micron-sized pores in interconnected tunnels allow oxygen diffusion. Moreover, defects and functional groups on graphene serve as catalytic sites and realized a metal-free catalytic process, ensuring a low over-potential of charging and discharging processes. With all these combined merits, this example has demonstrated a Li-air battery with a discharge capacity over about 2,800 mAh/g and a negligible potential polarization for over stable 50 cycles in ambient conditions. The results demonstrate that a scalable, high cathode capacity, long life cycle Li-air battery is obtainable by adopting the rationally designed moisture-resistive graphene membrane cathode. And this can open up opportunities and perspectives towards the future high energy storage systems.

Methods

Li-Air Cell Assembling

Cells were assembled in an argon filled glove box with water and oxygen contents both kept less than about 0.1 ppm. A positive top cover was machine-drilled to create holes to allow gas diffusion. Each cell included a metallic Li foil anode and the afore-mentioned graphene cathode with a carbon paper as a current collector. A Celgard separator separates the cathode from the anode. An about 1 M solution of lithium nitrate (LiNO₃)/N,N-dimethylacetamide (DMA) is used as an electrolyte.

Electrochemical Measurement

For the test in pure oxygen, an as-prepared Li-air cell was kept in a custom-made glass chamber, flowing with oxygen when testing. For the test in ambient conditions, an as-prepared Li-air cell was put directly in ambient air. Galvanostatic discharge/charge was performed with Maccor 4340, and cyclic voltammetry measurement was performed with a 3-electrode configuration on VersaSTAT 4 from Princeton Applied Research.

SEM and XRD Analysis

A scanning electron microscope (SEM JEOL 6700) was used to observe the morphology of an air cathode. XRD pattern was carried out using Bruker Smart 1000K Single Crystal X-ray Diffractometer.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the terms “connect,” “connected,” and “connection” refer to an operational coupling or linking. Connected objects can be directly coupled to one another or can be indirectly coupled to one another, such as via another set of objects.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A metal-air battery comprising:
a metal anode;
a cathode including a graphene membrane; and
an electrolyte disposed between the metal anode and the cathode,
wherein the graphene membrane includes graphene in an amount of at least 80% by weight of the graphene membrane.

2. The metal-air battery of claim 1, wherein the metal anode is a lithium metal anode, and the electrolyte is an aprotic electrolyte.

3. The metal-air battery of claim 1, wherein the graphene membrane includes graphene in the amount of at least 90% by weight of the graphene membrane.

4. The metal-air battery of claim 1, wherein the graphene membrane includes interconnected graphene sheets that form a porous structure.

5. The metal-air battery of claim 4, wherein a pore size of the graphene membrane is at least 100 nm.

6. The metal-air battery of claim 1, wherein the graphene membrane has a specific surface area of at least 1,000 m² g⁻¹.

7. The metal-air battery of claim 1, wherein the graphene membrane has an electrical conductivity of at least 500 S m⁻¹.

8. The metal-air battery of claim 1, wherein the graphene membrane forms a contact angle of at least 100° with respect to liquid water.

9. The metal-air battery of claim 1, wherein the cathode further includes a current collector, and the graphene membrane is coated on the current collector.

10. The metal-air battery of claim 9, wherein the current collector is a fibrous layer.

11. The metal-air battery of claim 1, wherein a thickness of the graphene membrane is at least 1 μm.

12. The metal-air battery of claim 1, wherein the cathode further includes a catalyst incorporated in the graphene membrane, and the catalyst is configured to catalyze at least one of oxygen reduction and oxygen evolution.

13. A metal-air battery comprising:
a metal anode;
a cathode including a graphene membrane and a catalyst incorporated in the graphene membrane, wherein the catalyst is configured to catalyze at least one of oxygen reduction and oxygen evolution; and
an electrolyte disposed between the metal anode and the cathode.

14. The metal-air battery of claim 13, wherein the metal anode is a lithium metal anode, and the electrolyte is an aprotic electrolyte.

15. The metal-air battery of claim 13, wherein the catalyst is a metal alloy catalyst.

16. The metal-air battery of claim 15, wherein the metal alloy catalyst is a ternary metal alloy catalyst.

17. A method of forming a cathode for a metal-air battery, comprising:
dispersing graphene oxide in a solvent to form a graphene oxide solution;
coating the graphene oxide solution on a current collector to form a coated current collector;
subjecting the coated current collector to cooling and dehydration to form a graphene oxide membrane on the current collector; and
annealing the graphene oxide membrane to form a graphene membrane on the current collector.

18. The method of claim 17, wherein subjecting the coated current collector to cooling and dehydration includes freeze-drying the coated current collector.

19. The method of claim 17, wherein annealing the graphene oxide membrane is carried out at a temperature in a range of 200° C. to 600° C.
